(19) United States
(12) Patent Application Publication
(10) Pub. No.: US 2010/0068554 A1
(43) Pub. Date: Mar. 18, 2010

(54) SYSTEM HAVING AT LEAST ONE METAL PART WHICH IS IN CONTACT WITH AT LEAST ONE PLASTIC COMPONENT

(76) Inventors: Lutz Mueller, Aichtal (DE); Bernard Walle, Hemmingen (DE)

Correspondence Address: KENYON & KENYON LLP, ONE BROADWAY, NEW YORK, NY, 10004, US

(21) Appl. No.: 12/304,848

(22) PCT Filed: Feb. 4, 2008
(86) PCT No.: PCT/EP2008/051335

§ 371 Date: Nov. 30, 2009

(30) Foreign Application Priority Data
Mar. 29, 2007 (DE) 10 2007 016 126.5

(51) Int. Cl. B32B 15/08

(52) U.S. Cl. 428/626

(57) ABSTRACT

In a system having at least one metal part which is in contact with at least one plastic component, the metal part has a galvanically applied aluminum surface coating.

### FIELD OF THE INVENTION

The present invention relates to a system having at least one metal part which is in contact with at least one plastic component.

### BACKGROUND INFORMATION

Systems of the type described above are known. Such systems are common in the automotive industry in particular. For example, pressed screens are inserted into or attached into/onto a plastic component for electrical contacting, a contact arising between the metal part (pressed screen) and the plastic component. Frequently, the position of the metal part is specifically determined or predefined by shaping the plastic component, which simplifies, for example, the mounting of the metal part on the plastic component. Corrosion may occur in the area of the contact which may cause the plastic component to be attacked, corroded, disintegrated or permanently damaged in the area of the contact, including under electrolytic action. This may result in loss of the contact and in the metal part becoming detached from the plastic component. In particular in the case of metal parts used for attaching other components such as threaded inserts which are integrated in the plastic component by extrusion coating, for example, such detachment must not occur.

DE 101 48 120 describes, for example, an electronic component having a semiconductor chip situated on a metallic system support, the metallic system support and the semiconductor chip being at least partially embedded in a plastic molding compound constituting the plastic component.

### SUMMARY

Example embodiments of the present invention provide that the metal part has a galvanically applied aluminum surface coating. A contact between the metal part and the plastic component arises accordingly between the plastic component and the aluminum surface coating of the metal part. If the metal part or the aluminum surface coating corrodes, a hydroxide which is formed reaches a maximum pH value of 10 and thus does not result in disintegration phenomena on the plastic component. As a result, the desired contact between the metal part and the plastic component is ensured permanently in a simple manner even in the presence of moisture or electrolytic action. The aluminum surface coating applied galvanically to the entire surface of the metal part is advantageously an aluminum surface coating applied by barrel electroplating, rack plating or strip coating.

Advantageously, the metal part is a pure metal part or an alloy metal part. The metal part may be an element used for the electrical contacting or also, for example, a heat sink or a mechanical fastener. The galvanically applied aluminum surface coating provides the metal part with a self-passivating surface, which in addition is readily cementable, coatable and may be bonded to aluminum wires. This has particular advantages with regard to use of the metal part as an electrically conductive element. If the metal part constitutes a heat sink, the thermal conductivity resistance of the aluminum surface coating compared to the thermal conductivity resistance of the adhesive coatings which are normally also used may be disregarded. The additionally favorable thermal expansion of a metal part made, for example, of steel and having an aluminum surface coating makes it possible to mount a chip directly, in particular a semiconductor chip. The galvanic application of the aluminum surface coating makes it possible for the metal part to have diverse shapes, it being possible to provide the aluminum surface coating on the entire surface in a simple manner using the aforementioned electroplating methods. This eliminates an expensive roll-bonding step for producing wire bond-capable or adhesible surfaces of the metal part in a manner which is reliable with regard to the process. Furthermore, there is the advantage that the metal part or its contactable surface is present in a clean condition after the electroplating process without additional cleaning processes.

In particular, the metal part is preferred to be a die cast or steel part. The galvanic application of the aluminum surface coating allows the use of favorable base materials, thus reducing the overall manufacturing costs. The galvanically applied aluminum surface coating also has high ductility and impact resistance so that the metal part in the plastic component also withstands high mechanical loads.

According to example embodiments of the present invention, the plastic component is a plastic housing. It is preferred in particular for the plastic housing to be a housing for a control unit or a sensor of a vehicle, in particular a motor vehicle. Such plastic housings frequently have integrated connecting plug devices which allow or make possible contacting of the electronics located in the housing. In this case, electrical contacts are formed by metal parts protruding through the housing wall, preferably in the form of pressed screen segments. To prevent moisture from penetrating into the plastic housing, the metal parts or contacts are held by the plastic housing by an interference fit. The design of the metal part having the galvanically applied aluminum surface coating in accordance with example embodiments of the present invention, as noted above, prevents the plastic housing from disintegrating in the area of the contact so that its impermeability is ensured permanently.

In example embodiments of the present invention, it is provided that the metal part is an inserted, cemented, built-in and/or extrusion coated part for the plastic component, in particular the plastic housing. For example, the metal part is a heat sink inserted or cemented into the plastic housing as described above. To that end, the plastic housing or plastic component advantageously has corresponding receiving cavities and/or receiving projections. A metal part constituting a pressed screen may, for example, be extrusion coated with plastic during assembly so that it is fixedly joined to it. Separation due to corrosion in the contact surface, or contact surfaces, is prevented as described above. Similarly, the metal part may constitute the above-described contacts of a connecting device separately or, for example, as a component of a pressed screen, the contacts projecting out of the housing through a housing wall. Similarly, metallic printed conductor structures may be provided as a cemented part. Additional metal parts, which may be provided as extrusion coated parts, are, for example, threaded inserts or fastening bolts having threads. In particular, they are preferably held on the plastic component or the plastic housing by a positive connection as a result of the extrusion coating. The advantageous design prevents the plastic in the area of the contact from disintegrating and accordingly the extrusion coated part is prevented from being separated from the plastic component or the plastic housing, as a result of which the function of the extrusion coated part, in particular its mechanical function, is ensured permanently.

According to example embodiments of the present invention, a plurality of metal parts having a galvanically applied aluminum surface coating is provided. Advantageously, all metal parts situated in a plastic housing have the galvanically applied aluminum surface coating on their (entire) surface. The result of this is that a galvanic corrosion of the metal connection points is avoided at metallic connection or contact points between two metal parts which are connected to one another, for example for electrical contacting. The provision of a galvanically applied aluminum surface coating on the entire surface of each metal part furthermore prevents the occurrence of corrosion at another point on the surface of the metal part.

In example embodiments of the present invention, the metal parts have different and/or the same base materials. Thus, metal parts may be provided in the advantageous system, each of which has a different material, all have the same base material or partially different base material and partially the same base material. For example, metal parts may be provided, one part of which has a first base material and the second part a second base material. The galvanically applied aluminum surface coating prevents corrosion, in particular at metal connection points.

It is advantageous in particular if the plastic housing is designed as a PBT (polybutylene terephthalate) or as a PET (polyethylene terephthalate) housing. The advantageous design of the metal part makes it readily possible to use such frequently used materials for the plastic housing or for the plastic component. Due to the aluminum surface coating, the aforementioned thermoplastic materials are not corroded even in the presence of moisture and electrolytic action. In a preferred embodiment, the plastic housing is a fiberglass-reinforced plastic housing, in particular a fiberglass-reinforced PBT or PET plastic housing.

Example embodiments of the present invention will be explained in greater detail below with reference to several drawings.

### BRIEF DESCRIPTION OF THE DRAWINGS

FIGS. 1a and 1b show an exemplary embodiment of an advantageous system,

FIG. 2 shows an exemplary embodiment of an advantageous system and

FIG. 3 shows an exemplary embodiment of an advantageous system.

### DETAILED DESCRIPTION

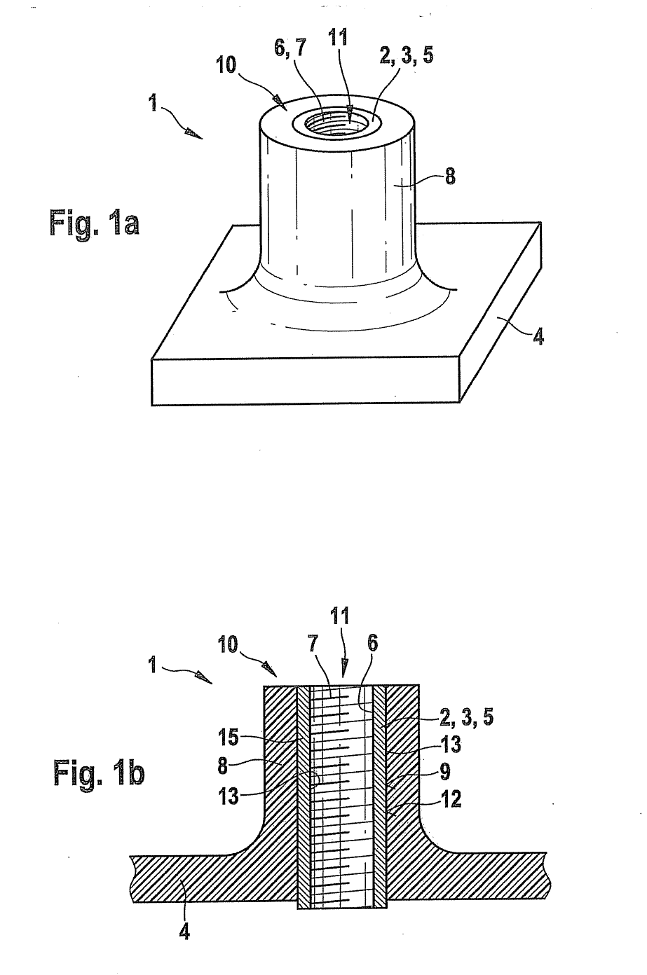

FIGS. 1a and 1b show an advantageous system 1 having a metal part 2 which is integrated in a plastic component 4 as an extrusion coated part 3. FIG. 1a shows system 1 in a perspective view while FIG. 1b shows system 1 in a cross-sectional view. Metal part 2 or extrusion coated part 3 is designed as an insert nut 5 which is arranged substantially as a circular cylinder and has a thread 7 in its interior 6 into which a fastening screw may be inserted. Plastic component 4, which is preferably made of polybutylene terephthalate (PBT) or polyethylene terephthalate (PET), has a cylindrical projection 8 which surrounds lateral surface 9 of insert nut 5. At its free end 10, projection 8 ends flush with insert nut 5, making insertion opening 11 of insert nut 5 freely accessible.

Entire surface 12 of insert nut 5 or of metal part 2 advantageously has a galvanically applied aluminum surface coating 13 or is formed thereby. Since metal part 2 is, as described above, designed as extrusion coated part 3, its lateral surface 9 is in contact with plastic component 4. The extrusion coating of metal part 2 holds it in plastic component 4. On the one hand, galvanically applied aluminum surface coating 13 increases the corrosion resistance of metal part 2, i.e., of insert nut 5. On the other hand, galvanically applied aluminum surface coating 13 prevents metal part 2 from being separated from plastic component 4 or the plastic from being damaged in the event of corrosion. Due to the aluminum surface coating 13, a hydroxide which is formed due to corrosion reaches a maximum pH value of 10, as a result of which no disintegration phenomena occur on plastic component 4 in the area of the contact, which would result in metal part 2 being separated from plastic component 4. Preferably, metal part 2 is designed as a pure metal part or an alloy metal part. In the present exemplary embodiment, metal part 2 is designed as a favorable die cast metal part 15.

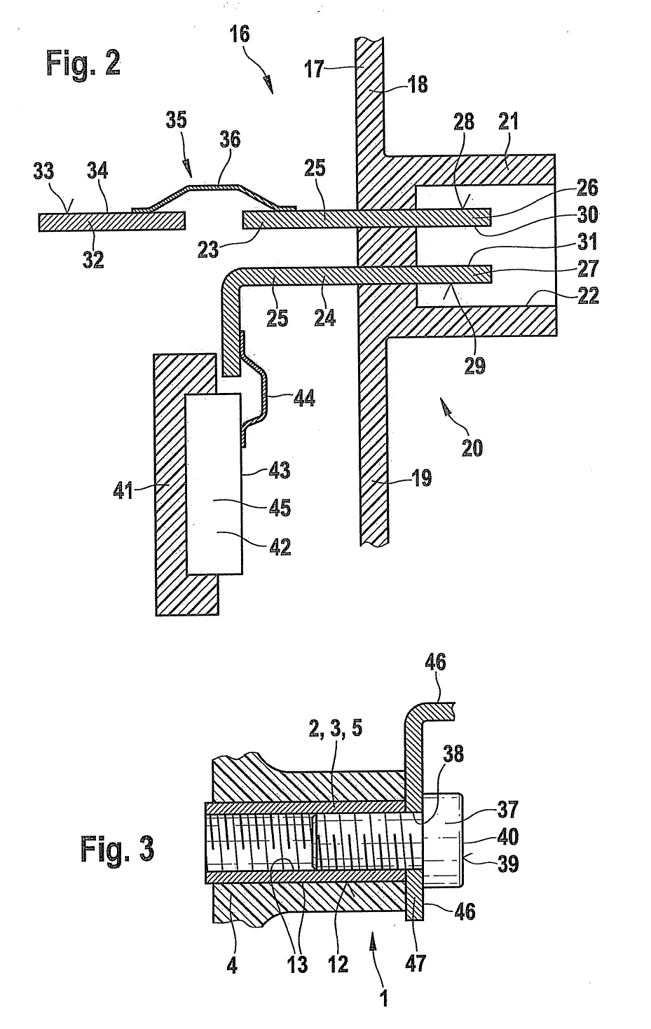

FIG. 2 shows another exemplary embodiment of an advantageous system 16 in a cross-sectional view. System 16 has a first plastic component 17 which is designed as a housing wall 18 of a plastic housing 19. Housing wall 18 has a connecting plug device 20 which is integrated in housing wall 18. Connecting plug device 20 has a projection 21 projecting essentially perpendicularly from housing wall 18 in which a plug receiver 22 is integrated. Projection 21 is preferably designed to be integral with housing wall 18. Situated in the area of connecting plug device 20 are two metal parts 23 and 24 which are designed as parts of a pressed screen 25 and are inserted through housing wall 18 in such a way that they protrude into a plug receiver 22 of connecting plug device 20, so that a plug inserted into connecting plug device 20 or plug receiver 22 is able to electrically contact pressed screen 25 or metal parts 23 and 24 and accordingly an electronic system located in plastic housing 19. Metal parts 23 and 24 of pressed screen 25 together with housing wall 18 form a complete electrical contact due to an interference fit. As already described above in relation to insert nut 5, surfaces 28, 29 of metal parts 23 and 24, which in this case are designed as mounting parts 26, 27, are in the form of a galvanically applied aluminum surface coating 30 and 31, respectively, which are in turn in contact with plastic component 17. Aluminum surface coating 30, 31 prevents plastic component 17 from being attacked by corrosion, as a result of which the impermeability of the compression joint might no longer be ensured.

Furthermore, system 16 has another metal part 32 whose entire surface 33 is also in the form of a galvanically applied aluminum surface coating 34. Independently of the base material of metal part 32 used, it is possible to produce an aluminum wire bond connection 35 using an aluminum bonding wire 36 between metal part 23 and metal part 32.

Furthermore, system 16 has a heat sink 42 at least partially embedded in plastic component 41, the heat sink having a galvanically applied aluminum surface coating 43 and being connected to metal part 24 or pressed screen 25 by an aluminum bonding wire 44. It is possible in a simple manner to remove heat via aluminum bonding wire 44 to heat sink 42 independently of the material of metal part 45 constituting heat sink 42. As noted above, it is possible to disregard the thermal conductivity resistance of aluminum surface coating 43 compared to the thermal conductivity resistance of the adhesive coatings normally used which would be necessary for a reliable and permanent contacting of heat sink 42 without aluminum surface coating 43.

FIG. 3 shows a further exemplary embodiment of system 1 described in FIGS. 1a and 1b. A metallic fastening screw 37 is inserted through an opening 38 of a metal part 47 having a galvanically applied aluminum surface coating 46 into insert nut 5 in order to attach metal part 47 additionally to plastic component 4 which may be a component of plastic housing 19. Advantageously, surface 39 of screw 37 also has a galvanically applied aluminum surface coating 40. Since the surfaces of metal parts 47, 2 and 37, which are now also in contact with one another, are formed by or have an aluminum surface coating 46, 13 and 40 or exhibit them, corrosion on the metallic contact points is effectively prevented.

The aluminum surface coating may be applied to above-described metal parts 2, 23, 24, 37 and 47 in a simple manner by a rack, strip or barrel electroplating.

1 to 15. (canceled)

16. A system, comprising:
at least one metal part in contact with at least one plastic component;
wherein the metal part has a galvanically applied aluminum surface coating.

17. The system according to claim 16, wherein the metal part is at least one of (a) a pure metal part and (b) an alloy metal part.

18. The system according to claim 16, wherein the metal part is a die cast part.

19. The system according to claim 16, wherein the plastic component is a plastic housing.

20. The system according to claim 16, wherein the metal part is at least one of (a) an inserted, (b) a cemented, (c) a built in, and (d) an extrusion coated part for at least one of (a) the plastic component and (b) the plastic component arranged as a plastic housing.

21. The system according to claim 16, wherein a plurality of metal parts are provided with an aluminum surface coating.

22. The system according to claim 16, wherein the metal parts have at least one of (a) different and (b) identical base materials.

23. The system according to claim 16, wherein the aluminum surface coating of the metal part is at least one of (a) a rack, (b) a strip, and (c) a barrel electroplated coating.

24. The system according to claim 16, wherein the plastic component is a plastic housing formed of at least one of (a) PBT (polybutylene terephthalate) and (b) PET (polyethylene terephthalate).

25. The system according to claim 19, wherein the plastic housing is a fiberglass-reinforced plastic housing.

26. The system according to claim 16, wherein the metal part is a socket.

27. The system according to claim 16, wherein the metal part is an insert nut.

28. The system according to claim 16, wherein the metal part is a heat sink.

29. The system according to claim 16, wherein the metal part is a pressed screen.

30. The system according to claim 16, wherein the metal part is at least one of (a) a machined, (b) a forged, and (c) a deep drawn at least one of (a) a socket and (b) an insert nut (5).
